(19) United States
(12) Patent Application Publication
(10) Pub. No.: US 2026/0063943 A1
(43) Pub. Date: Mar. 5, 2026

(54) DISPLAY DEVICE

(71) Applicant: Japan Display Inc., Tokyo (JP)

(72) Inventors: Yasuhiro TAKAHASHI, Tokyo (JP); Junko NAGASAWA, Tokyo (JP)

(21) Appl. No.: 19/314,231

(22) Filed: Aug. 29, 2025

(30) Foreign Application Priority Data
Sep. 3, 2024 (JP) 2024-151397

(51) Int. Cl. G02F 1/1334; G02F 1/1333; G02F 1/1335; G02F 1/13357

(52) U.S. Cl. CPC G02F 1/1334; G02F 1/133368; G02F 1/133524; G02F 1/133553; G02F 1/133615

(57) ABSTRACT

According to one embodiment, a display device includes a display panel and a light source unit provided along an edge portion of the display panel. The display panel includes a first transparent substrate, a second transparent substrate, a liquid crystal layer sealed between the first transparent substrate and the second transparent substrate, a third transparent substrate facing the first transparent substrate, and a selective reflective layer located between the first transparent substrate and the third transparent substrate. The selective reflective layer is configured to transmit light in a blue wavelength range and light in a green wavelength range and reflect light in a red wavelength range at a predetermined incident angle relative to its normal.

### CROSS-REFERENCE TO RELATED APPLICATIONS

This application is based upon and claims the benefit of priority from Japanese Patent Application No. 2024-151397, filed Sep. 3, 2024, the entire contents of which are incorporated herein by reference.

### FIELD

Embodiments described herein relate generally to a display device.

### BACKGROUND

Various types of display devices employing polymer dispersed liquid crystals capable of switching a scattering state of scattering incident light and a transparent state of transmitting incident light have been proposed. The display devices using polymer dispersed liquid crystals adopt an edge-lit method in which light emitting modules are arranged at the edge portions of the display panel.

In such display devices, suppressing degradations in display quality is demanded.

### BRIEF DESCRIPTION OF THE DRAWINGS

FIG. 1 is a diagram showing a configuration example of a display device 1.

FIG. 2 is a cross-sectional view of the display device 1 along the A-B line of FIG. 1.

FIG. 3 is a diagram showing an example of the layout of a circuit portion included in a display panel 100.

FIG. 4 is a cross-sectional view of the display panel 100 along the C-D line of FIG. 3.

FIG. 5A is a diagram for describing one property required for a selective reflective layer 300.

FIG. 5B is a diagram for describing another property required for the selective reflective layer 300.

FIG. 6A is a diagram for describing a reflection property of the selective reflective layer 300.

FIG. 6B is a diagram for describing a transmission property of the selective reflective layer 300.

FIG. 7 is a diagram for describing the function of the selective reflective layer 300 in the display panel 100.

FIG. 8 is a diagram showing an application example 1 of the display device 1.

FIG. 9 is a diagram showing an application example 2 of the display device 1.

### DETAILED DESCRIPTION

In general, according to one embodiment, a display device includes a display panel and a light source unit provided along an edge portion of the display panel. The display panel includes a first transparent substrate, a second transparent substrate facing the first transparent substrate, a liquid crystal layer sealed between the first transparent substrate and the second transparent substrate and including a polymer dispersed liquid crystal containing polymers and liquid crystal molecules, a third transparent substrate facing the first transparent substrate, and a selective reflective layer located between the first transparent substrate and the third transparent substrate. The selective reflective layer is configured to transmit light in a blue wavelength range and light in a green wavelength range and reflect light in a red wavelength range at a predetermined incident angle relative to its normal.

Embodiments will be described with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the figures, an X-axis, a Y-axis, and a Z-axis orthogonal to each other are described to facilitate understanding as needed. A direction parallel to the X-axis is referred to as a first direction X. A direction parallel to the Y-axis is referred to as a second direction Y. A direction parallel to the Z-axis is referred to as a third direction Z. A plan view is defined as appearance when various types of elements are viewed parallel to the third direction Z. When terms indicating the positional relationships of two or more structural elements, such as “on”, “above” “between” and “face”, are used, the target structural elements may be directly in contact with each other or may be spaced apart from each other as a gap or another structural element is interposed between them.

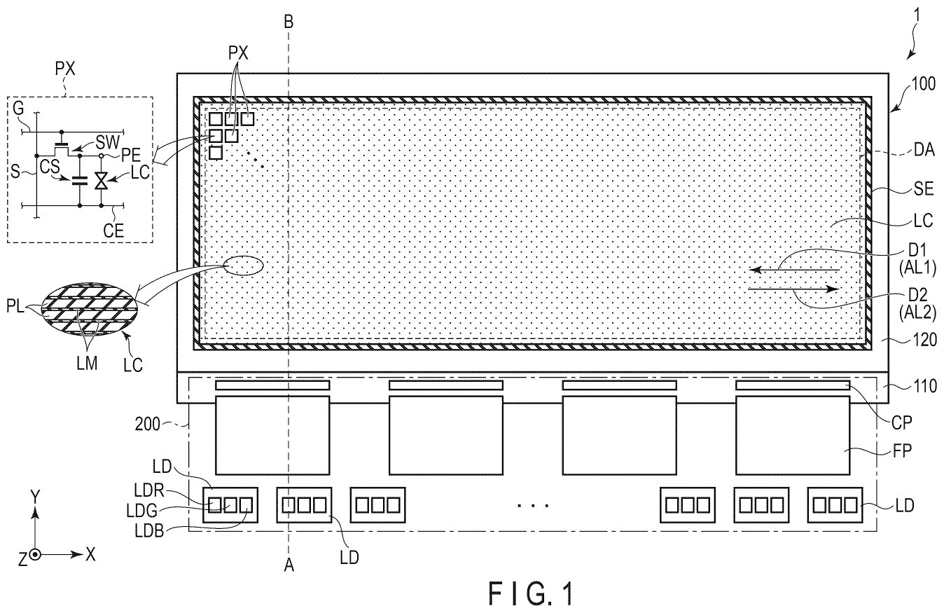

FIG. 1 is a diagram showing a configuration example of a display device 1.

The display device 1 comprises a display panel 100 configured to display images and a light source unit 200 configured to illuminate the display panel 100.

The display panel 100 comprises a transparent substrate 110, a transparent substrate 120, a liquid crystal layer LC, and a seal SE. Each of the transparent substrates 110 and 120 is formed into a plate-like shape parallel to an X-Y plane defined by the first direction X and the second direction Y. The transparent substrates 110 and 120 overlap each other in plan view. The transparent substrate 110 extends in the second direction Y further compared to the transparent substrate 120. In the illustrated example, each of the transparent substrates 110 and 120 is formed into a rectangle extending in the first direction X. The shapes are not limited to this example. For example, each of the transparent substrates 110 and 120 may be a square or any shapes different from a rectangle, such as a polygon, a circle, an oval, and a semicircle.

The liquid crystal layer LC is located between the transparent substrates 110 and 120, provided across a display area DA for displaying images, and sealed with the seal SE. An alignment processing direction D1 of an alignment film AL1 located between the transparent substrate 110 and the liquid crystal layer LC is parallel to and opposite to an alignment processing direction D2 of an alignment film AL2 located between the transparent substrate 120 and a liquid crystal layer LC1. In the illustrated example, the alignment processing directions D1 and D2 both are parallel to the first direction X. The alignment processing applied to each of the alignment films AL1 and AL2 may be either rubbing processing or photo-alignment processing.

As shown schematically and enlarged manner in the figure, the liquid crystal layer LC comprises a polymer dispersed liquid crystal containing polymers PL and liquid crystal molecules LM. In one example, the polymers PL are liquid crystal polymers. Each of the polymers PL and the liquid crystal molecules LM has optical anisotropy or refractive anisotropy. The responsiveness of the polymers PL for an electric field is lower than that of the liquid crystal molecules LM for an electric field.

As described above, the alignment processing directions D1 and D2 are parallel to the first direction X. Thus, each of the polymers PL is formed in a streaky shape extending along the first direction X. The liquid crystal molecules LM are dispersed in the gaps of the polymers PL and are aligned such that their long axes are along the first direction X. That is, the initial alignment direction of the liquid crystal molecules LM is set to the first direction X.

For example, the alignment direction of the polymers PL hardly varies irrespective of the presence or absence of the electric field. In contrast, the alignment direction of the liquid crystal molecules LM varies according to the electric field in a state where a high voltage greater than or equal to a threshold is applied to the liquid crystal layer LC. In a state where no voltage is applied to the liquid crystal layer LC, the optical axes of the polymers PL are parallel to those of the liquid crystal molecules LM, and light entering the liquid crystal layer LC is not substantially scattered inside the liquid crystal layer LC and passes through the liquid crystal layer LC (the transparent state). In a state where a voltage is applied to the liquid crystal layer LC, the optical axes of the polymers PL intersect those of the liquid crystal molecules LM, and light entering the liquid crystal layer LC is scattered inside the liquid crystal layer LC (the scattered state).

The configuration of the polymer dispersed liquid crystal containing the polymers PL and the liquid crystal molecules LM is not limited to the example described above.

The display area DA comprises a plurality of pixels PX arranged in a matrix in the first direction X and the second direction Y.

As shown in enlarged manner in the figure, each pixel PX comprises a switching element SW, a pixel electrode PE, a common electrode CE, a liquid crystal layer LC, and the like. The switching element SW is constituted by, for example, a thin-film transistor (TFT) and is electrically connected to a scanning line G and a signal line S.

The scanning line G extends in the first direction X and is electrically connected to the switching element SW of each of the pixels PX arranged in the first direction X. That is, the alignment processing directions D1 and D2 are parallel to the scanning line G. Further, the polymers PL in the streaky shape extend along the scanning line G.

The signal line S extends in the second direction Y, intersects the scanning line G, and is electrically connected to the switching element SW of each of the pixels PX arranged in the second direction Y. That is, the alignment processing directions D1 and D2 intersect or are orthogonal to the signal line S. Further, the polymers PL in the streaky shape extend to intersect the signal line S.

The pixel electrode PE is electrically connected to the switching element SW. Each pixel electrode PE faces the common electrode CE, and drives the liquid crystal layer LC by an electric field produced between the pixel electrode PE and the common electrode CE (in particular, the liquid crystal molecules LM). A capacitor CS is formed, for example, between an electrode having the same electric potential as the common electrode CE and an electrode having the same potential as the pixel electrode PE.

The scanning line G, the signal line S, the switching element SW, and the pixel electrode PE are provided between the transparent substrate 110 and the liquid crystal layer LC1. The common electrode CE is provided between the transparent substrate 120 and the liquid crystal layer LC.

An IC chip CP and a flexible printed circuit board FP are mounted on the transparent substrate 110.

The light source unit 200 is provided along an edge portion extending in the first direction X of the display panel 100. The light source unit 200 is configured to emit illumination light with which the liquid crystal layer LC is illuminated. The light source unit 200 comprises a plurality of light emitting elements LD arranged with intervals in the first direction X. Each of the plurality of light emitting elements LD comprises a red light emitting portion LDR, a green light emitting portion LDG, and a blue light emitting portion LDB as light emitting portions.

The red light emitting portion LDR is configured to emit red light of a main wavelength λr. The green light emitting portion LDG is configured to emit green light of a main wavelength λg. The blue light emitting element LDB is configured to emit blue light of a main wavelength λb. These red light emitting element LDR, green light emitting element LDG, and blue light emitting element LDB are configured to be turned on sequentially. The red light emitting element LDR, the green light emitting element LDG, and the blue light emitting element LDB may all be turned on simultaneously.

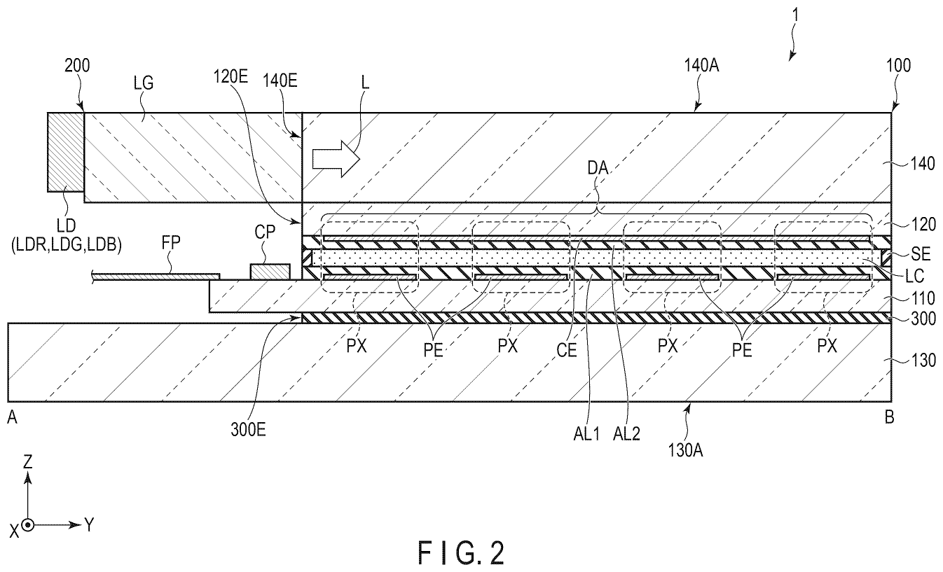

FIG. 2 is a cross-sectional view of the display device 1 along the A-B line of FIG. 1.

The illustration of the scanning lines, signal lines, switching elements, insulating films, etc. described above in the display panel 100 is omitted, and only the main elements necessary for explanation are shown in the figure.

The transparent substrates 110 and 120 face each other in the third direction Z. The liquid crystal layer LC is located between the transparent substrates 110 and 120. The pixel electrode PE of each of the pixels PX is located between the transparent substrate 110 and the liquid crystal layer LC and is covered with the alignment film AL1. The common electrode CE facing the plurality of pixel electrodes PE is located between the transparent substrate 120 and the liquid crystal layer LC and is covered with the alignment film AL2. The liquid crystal layer LC contacts the alignment films AL1 and AL2. For example, each of the pixel electrode PE and the common electrode CE is a transparent electrode formed of a transparent conductive material such as an indium tin oxide (ITO).

In the illustrated example, the display panel 100 further comprises a transparent substrate 130, a transparent substrate 140, and a selective reflective layer 300. The transparent substrates 130 and 140 face each other in the third direction Z. The transparent substrates 110 and 120 and the liquid crystal layer LC are located between the transparent substrates 130 and 140 in the third direction Z. The selective reflective layer 300 is located between the transparent substrates 110 and 130. The selective reflective layer 300 is provided to overlap at least the entire display area DA. In the illustrated example, the selective reflective layer 300 has an edge portion 300E that overlaps a side surface 120E of the transparent substrate 120.

In cases where the sheet-like selective reflective layer 300 is provided between the transparent substrates 110 and 130, the selective reflective layer 300 is adhered to one of the transparent substrates 110 and 130, and is preferably adhered to both of the transparent substrates 110 and 130.

In cases where the selective reflective layer 300 is directly formed on the transparent substrate 110, the selective reflective layer 300 is preferably adhered to the transparent substrate 130. Alternatively, in cases where the selective reflective layer 300 is directly formed on the transparent substrate 130, the selective reflective layer 300 is preferably adhered to the transparent substrate 110.

The adhesive layer for bonding the selective reflective layer 300 is preferably transparent and preferably has a refractive index nearly equivalent to those of the transparent substrates 110 and 130. No air layer is interposed between the selective reflective layer 300 and the transparent substrate 110 and between the selective reflective layer 300 and the transparent substrate 130. This suppresses undesirable interface reflection.

The transparent substrate 140 is adhered to the transparent substrate 120. In the illustrated example, the side surface 120E of the transparent substrate 120 and a side surface 140E of the transparent substrate 140 overlap in the third direction Z. Each of the side surfaces 120E and 140E extends in the first direction X. The transparent substrate 140 may extended in the second direction Y further compared to the transparent substrate 120. In this case, the side surface 120E of the transparent substrate 120 is located between the side surface 140E of the transparent substrate 140 and the display area DA in the second direction Y.

A main surface 130A of the transparent substrate 130 and a main surface 140A of the transparent substrate 140 are both parallel to the X-Y plane and contact air.

The light source unit 200 faces the side surface 140E of the transparent substrate 140 in the second direction Y. In this case, the side surface 140E corresponds to the edge portion of the display panel 100. The light source unit 200 may face both of the side surfaces 120E and 140E. The light source unit 200 comprises the light emitting element LD and a light guide LG. The light guide LG is located between the light emitting element LD and the transparent substrate 140 in the second direction Y.

The transparent substrates 110 and 120 are colorless and transparent glass substrates that are formed of the same material. In one example, the transparent substrates 110 and 120 are formed of alkali-free glass or optical glass.

The transparent substrate 130 is a glass substrate formed of a material different from those of the transparent substrates 110 and 120. In one example, the transparent substrate 130 is formed of soda-lime glass (float glass). Such transparent substrate 130 is a window glass or an automotive glass.

The transparent substrate 140 is formed of a material different from that of the transparent substrate 130. In one example, the transparent substrate 140 is a glass substrate formed of the same material as that of the transparent substrate 120. The transparent substrate 140 may be a resinous substrate.

The transparent substrates 130 and 140 function as cover members. The transparent substrate 140 functions as a light guide that propagates an illumination light L, which has been emitted from the light source unit 200, along the second direction Y.

In one example, the transparent substrate 130 is thicker than the transparent substrate 110, and the transparent substrate 140 is thicker than the transparent substrate 120. The transparent substrate 140 may be omitted. When the transparent substrate 140 is omitted, the light source unit 200 is provided to face the side surface 120E of the transparent substrate 120 in the second direction Y.

This display panel 100 is driven in synchronization with the light source unit 200. For example, during the period when each pixel PX is driven based on a red image signal and a potential is maintained at all of the pixels PX in the display panel 100, the red light emitting portion LDR of the light source unit 200 is turned on.

Then, during the period when each pixel PX is driven based on a green image signal and a potential is maintained at all of the pixels PX in the display panel 100, the green light emitting portion LDG of the light source unit 200 is turned on. Then, during the period when each pixel PX is driven based on a blue image signal and a potential is maintained at all of the pixels PX in the display panel 100, the blue light emitting portion LDB of the light source unit 200 is turned on.

When a voltage greater than a threshold is applied to the liquid crystal layer LC of each pixel PX, the liquid crystal layer LC transitions to the scattered state. The illumination light L emitted from the light source unit 200 is scattered by the liquid crystal layer LC of each pixel PX and becomes display light. Then, a color image is displayed in the display area DA. The display light emitted from the display panel 100 is linearly polarized light parallel to the first direction X.

When the liquid crystal layer LC is in the transparent state and the display panel 100 is observed from the main surface 130A side, the background can be observed through the display panel 100. Similarly, when the display panel 100 is observed from the main surface 140A side, the background can be observed through the display panel 100.

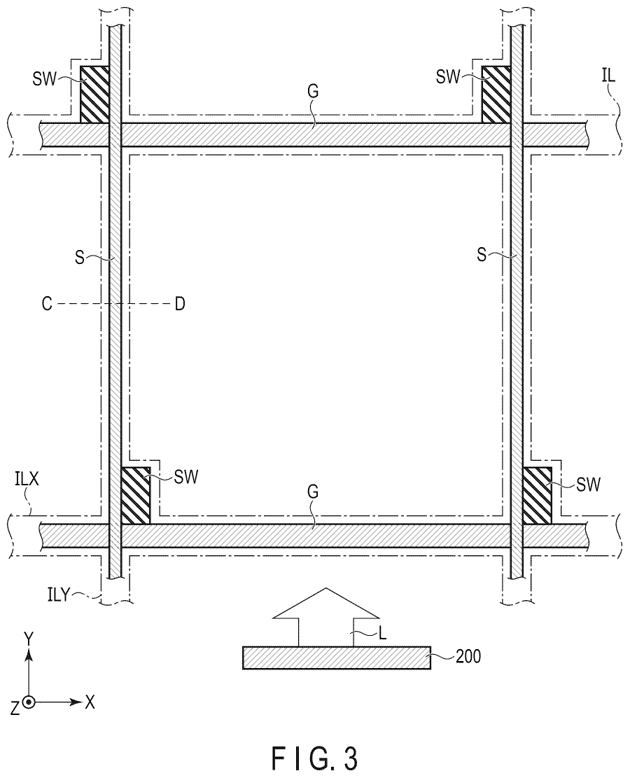

FIG. 3 is a diagram showing an example of the layout of the circuit portion included in the display panel 100.

The plurality of scanning lines G each extend in the first direction X and are arranged in the second direction Y. The plurality of signal lines S each extend in the second direction Y and are arranged in the first direction X. The switching element SW is illustrated here in simplified manner and provided at the intersection of the scanning lines G and the signal lines S.

An insulating layer IL indicated by the one-dot chain line is formed in a grating shape. The insulating layer IL has a first portion ILX extending in the first direction X and a second portion ILY extending in the second direction Y. The first portion ILX mainly overlaps the scanning line G. The second portion ILY mainly overlaps the signal line S.

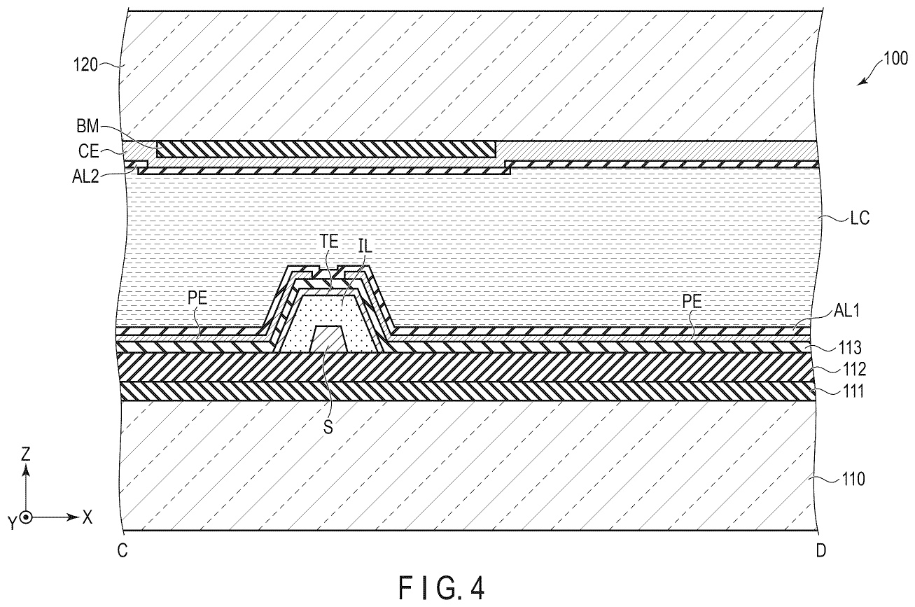

FIG. 4 is a cross-sectional view of the display panel 100 along the C-D line of FIG. 3.

The insulating layer 111 is provided on the transparent substrate 110. The insulating layer 112 is provided on the insulating layer 111. Each of the insulating layers 111 and 112 is an inorganic insulating layer formed of, for example, a silicon oxide, a silicon nitride, and a silicon oxynitride.

The scanning line G shown in FIG. 3 is provided between the insulating layers 111 and 112. The signal line S is provided on the insulating layer 112. The insulating layer IL is provided on the insulating layer 112. In the illustrated cross section, the insulating layer IL covers the signal line S. The insulating layer IL is an organic insulating layer.

A transparent electrode TE covers the insulating layer IL. The transparent electrode TE is formed of a transparent conductive material such as an ITO. The insulating layer 113 is provided on the insulating layer 112 and covers the transparent electrode TE. The pixel electrode PE is provided on the insulating layer 113. The insulating layer 113 is an inorganic insulating layer located between the transparent electrode TE and the pixel electrode PE. The alignment film AL1 covers the pixel electrode PE and the insulating layer 113 and contacts the liquid crystal layer LC.

A light-shielding layer BM is provided between the transparent substrate 120 and the liquid crystal layer LC. The light-shielding layer BM is located directly above the signal line S and directly above the insulating layer IL. Though not illustrated, the light-shielding layer BM is located directly above the scanning line G and the switching element SW.

The common electrode CE faces the pixel electrode PE and covers the light-shielding layer BM in the third direction Z. The alignment film AL2 covers the common electrode CE and contacts the liquid crystal layer LC.

Next, the following describes the selective reflective layer 300 applicable to the present embodiment.

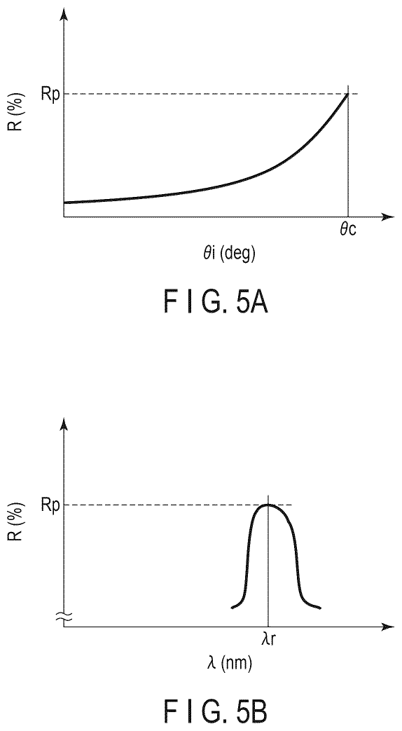

FIG. 5A is a diagram for describing one property required for the selective reflective layer 300.

The horizontal axis of the figure represents an incident angle θi (deg) of light entering the selective reflective layer 300, and the vertical axis represents a reflectance R (%). When light in the red wavelength range enters the selective reflective layer 300, the reflectance R reaches its maximum value Rp at incident angles θi equal to or greater than a critical angle θc at which total reflection is caused.

FIG. 5B is a diagram for describing another property required for the selective reflective layer 300.

The horizontal axis of the figure represents a wavelength λ (nm) of light entering the selective reflective layer 300, and the vertical axis represents the reflectance R (%). The incident angle θi of light entering the selective reflective layer 300 is assumed to be greater than the critical angle θc for the light in the red wavelength range shown in FIG. 5A.

The selective reflective layer 300 almost transmit both of light in the blue wavelength range and light in the green wavelength range. Thus, the reflectance of light in the blue wavelength range and light in the green wavelength range in the selective reflective layer 300 each is extremely small. In contrast, light in the red wavelength range is almost entirely reflected in the selective reflective layer 300. Further, the wavelength range in which the reflectance R reaches its maximum value Rp in the selective reflective layer 300 includes the main wavelength λr of the red light emitting portion LDR of the light emitting element LD.

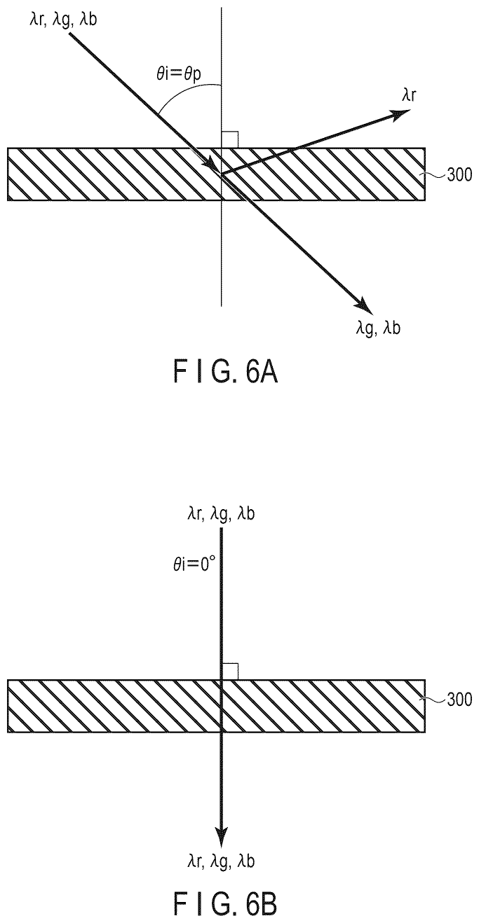

FIG. 6A is a diagram for describing a reflection property of the selective reflective layer 300.

The light entering the selective reflective layer 300 includes red light of the main wavelength λr emitted from the red light emitting portion LDR, green light of the main wavelength λg emitted from the green light emitting portion LDG, and blue light of the main wavelength λb emitted from the blue light emitting portion LDB. The incident angle θi relative to the normal of the selective reflective layer 300 is a predetermined incident angle θp that is greater than the critical angle θc shown in FIG. 5A.

The selective reflective layer 300 is configured to, at the incident angle θp, transmit blue light of the main wavelength λb and green light of the main wavelength λg, and reflect red light of the main wavelength λr.

FIG. 6B is a diagram for describing a transmission property of the selective reflective layer 300.

The selective reflective layer 300 is configured to transmit all of blue light of the main wavelength λb, green light of the main wavelength λg, and red light of the main wavelength λr, when light enters from the normal direction, in other words, at the incident angle θi of 0°.

The selective reflective layer 300 is, for example, formed as a dielectric multilayer film. In one example, PICASUS manufactured by Toray Industries, Inc. is applicable to the selective reflective layer 300.

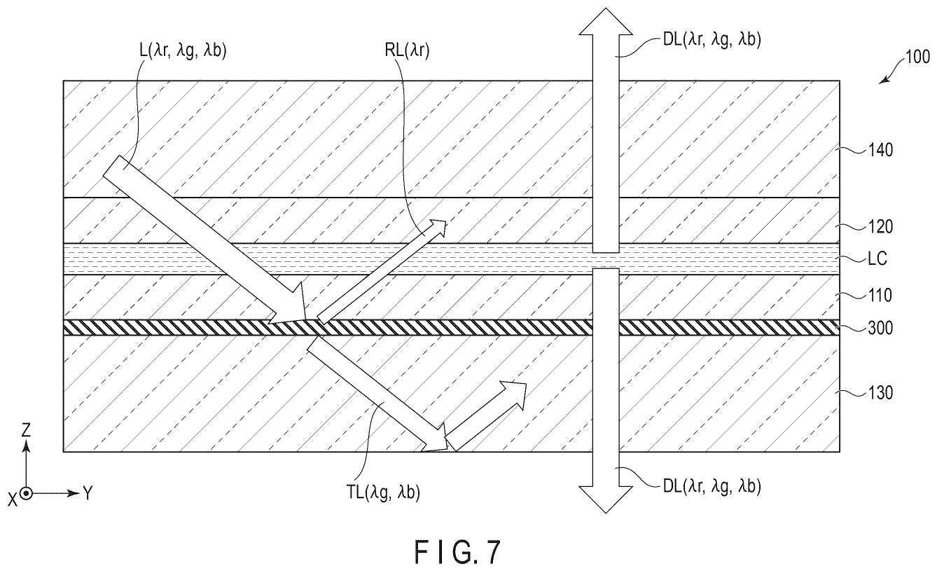

FIG. 7 is a diagram for describing the function of the selective reflective layer 300 in the display panel 100.

When the transparent substrate 130 is an automotive glass having a blue color, the transparent substrate 130 has a higher absorption rate for light in the red wavelength range compared to the transparent substrate 110. Thus, for red light of the main wavelength λr among the illumination light L, the absorption rate of the transparent substrate 130 is higher than that of the transparent substrate 110.

When the illumination light L enters this transparent substrate 130, the absorption rate of red light of the main wavelength λr in the transparent substrate 130 is higher than that of blue light of the main wavelength λb in the transparent substrate 130, and also higher than that of green light of the main wavelength λg in the transparent substrate 130. Thus, when blue light of the main wavelength λb, green light of the main wavelength λg, and red light of the main wavelength λr contained in the illumination light L sequentially enter the transparent substrate 130, the red component of the illumination light L becomes insufficient. Thus, the desired color of white cannot be obtained, and the color of the illumination light L shifts to a cyan-type color.

Thus, in the present embodiment, the selective reflective layer 300 having the above property is provided between the transparent substrates 110 and 130. The following describes an optical function of the illumination light L.

Blue light of the main wavelength λb, green light of the main wavelength λg, and red light of the main wavelength λr contained in the illumination light L proceed from the transparent substrate 140 toward the transparent substrate 120, pass through the liquid crystal layer LC and the transparent substrate 110, and then reach the selective reflective layer 300. In the selective reflective layer 300, red light of the main wavelength λr of the illumination light L becomes a reflected light RL. Further, in the selective reflective layer 300, each of blue light of the main wavelength λb and green light of the main wavelength λg of the illumination light L becomes a transmitted light TL. The reflected light RL is reflected by the selective reflective layer 300 and then proceeds toward the liquid crystal layer LC. The transmitted light TL is reflected at the interface between the transparent substrate 130 and air, then passes through the selective reflective layer 300, and proceeds toward the liquid crystal layer LC.

In this way, red light hardly reaches the transparent substrate 130. This suppresses undesirable absorption of red light in the transparent substrate 130. Furthermore, red light reflected by the selective reflective layer 300 and green light and blue light that have passed through the transparent substrate 130 proceed toward the liquid crystal layer LC again. Thus, the color of the illumination light L can be maintained at the desired white color.

A display light DL obtained by the illumination light L being scattered in the liquid crystal layer LC includes blue light of the main wavelength λb, green light of the main wavelength λg, and red light of the main wavelength λr. The display light DL passes through the transparent substrates 130 and 140. In particular, a user facing the transparent substrate 140 can observe the display light DL of the desired color.

As described above, the present embodiment can suppress degradations in display quality resulting from the optical property of the transparent substrate 130.

Next, the following describes application examples of the display device 1.

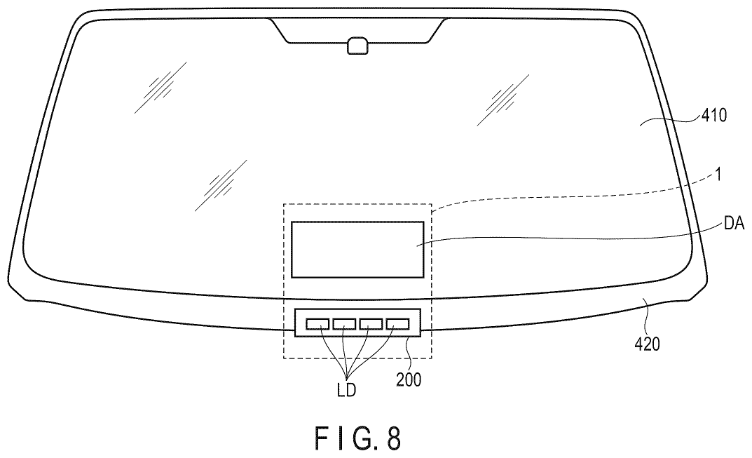

FIG. 8 is a diagram showing an application example 1 of the display device 1.

The application example 1 corresponds to cases where the display device 1 is provided in the front side of a vehicle. The transparent substrate 130 of the display device 1 is a front window 410. The display area DA overlaps the front window 410. The light source unit 200 including the light emitting elements LD is provided in a frame 420 surrounding the front window 410 or in a dashboard.

In this application example 1, a driver or passengers of the vehicle can visually recognize the front of the vehicle through the front window 410 and can also visually recognize the image displayed in the display area DA.

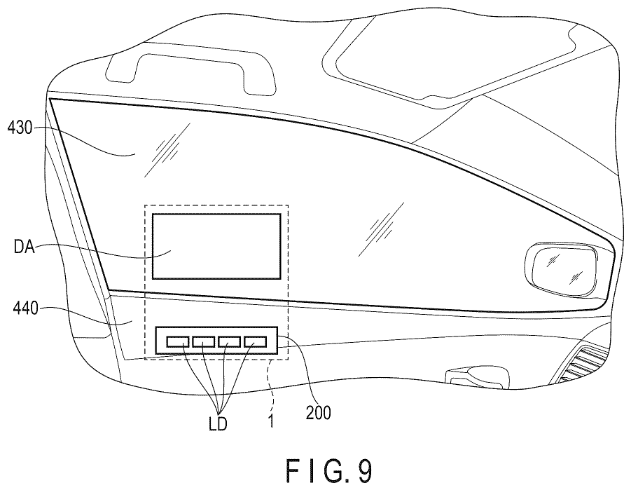

FIG. 9 is a diagram showing an application example 2 of the display device 1.

The application example 2 corresponds to cases where the display device 1 is provided on the side of a vehicle. The transparent substrate 130 of the display device 1 is a side window 430. The display area DA overlaps the side window 430. The light source unit 200 including the light emitting elements LD is provided in a door frame 440.

In this application example 2, a driver and passengers of the vehicle can visually recognize the side of the vehicle through the side window 430 and can also visually recognize the image displayed in the display area DA.

In the above present embodiment, for example, the transparent substrate 110 corresponds to the first transparent substrate, the transparent substrate 120 corresponds to the second transparent substrate, the transparent substrate 130 corresponds to the third transparent substrate, and the transparent substrate 140 corresponds to the fourth transparent substrate.

As explained above, the embodiment can provide a display device capable of suppressing degradations in display quality.

All of the display devices that can be implemented by a person of ordinary skill in the art through arbitrary design changes to the display device described above as the embodiment of the present invention come within the scope of the present invention as long as they are in keeping with the spirit of the present invention.

Various modification examples which may be conceived by a person of ordinary skill in the art in the scope of the idea of the present invention will also fall within the scope of the invention. For example, even if a person of ordinary skill in the art arbitrarily modifies the above embodiments by adding or deleting a structural element or changing the design of a structural element, or by adding or omitting a step or changing the condition of a step, all of the modifications fall within the scope of the present invention as long as they are in keeping with the spirit of the invention.

Further, other effects which may be obtained from the above embodiments and are self-explanatory from the descriptions of the specification or can be arbitrarily conceived by a person of ordinary skill in the art are considered as the effects of the present invention as a matter of course.

What is claimed is:

1. A display device, comprising:
a display panel; and
a light source unit provided along an edge portion of the display panel, wherein
the display panel comprises:
a first transparent substrate;
a second transparent substrate facing the first transparent substrate;
a liquid crystal layer sealed between the first transparent substrate and the second transparent substrate and including a polymer dispersed liquid crystal containing polymers and liquid crystal molecules;
a third transparent substrate facing the first transparent substrate; and
a selective reflective layer located between the first transparent substrate and the third transparent substrate, wherein
the selective reflective layer is configured to transmit light in a blue wavelength range and light in a green wavelength range and reflect light in a red wavelength range at a predetermined incident angle relative to its normal.

2. The display device of claim 1, wherein
the selective reflective layer is configured to transmit light in the blue wavelength range, light in the green wavelength range, and light in the red wavelength range at an incident angle of 0°.

3. The display device of claim 1, wherein
the light source unit comprises a red light emitting portion configured to emit red light, and
a main wavelength of red light emitted from the red light emitting portion is included in a wavelength range in which a reflectance becomes its maximum value in the selective reflection layer.

4. The display device of claim 1, wherein
the third transparent substrate is formed of a material different from those of the first transparent substrate and the second transparent substrate.

5. The display device of claim 4, wherein
the light source unit comprises a red light emitting portion configured to emit red light, and
an absorption rate of the third transparent substrate at a main wavelength of red light emitted from the red light emitting portion is higher than an absorption rate of the first transparent substrate.

6. The display device of claim 1, wherein
the light source unit comprises:
a red light emitting portion configured to emit red light;
a green light emitting portion configured to emit green light; and
a blue light emitting portion configured to emit blue light, and
the red light emitting portion, the green light emitting portion, and the blue light emitting portion are configured to be sequentially turned on.

7. The display device of claim 1, wherein
the display panel further comprises a fourth transparent substrate facing the second transparent substrate and adhered to the second transparent substrate, and
the light source unit comprises:
a light emitting element configured to emit light, and
a light guide located between the light emitting element and a side surface of the fourth transparent substrate.

8. The display device of claim 7, wherein
the fourth transparent substrate is formed of a material different from that of the third transparent substrate and equivalent to that of the second transparent substrate.

9. The display device of claim 1, wherein
the third transparent substrate is formed of soda-lime glass.

10. The display device of claim 1, wherein
the third transparent substrate is an automotive glass.

11. The display device of claim 1, wherein
the display panel further comprises between the first transparent substrate and the liquid crystal layer:
a scanning line;
a signal line intersecting the scanning line;
a switching element electrically connected to the scanning line and the signal line;
a pixel electrode electrically connected to the switching element;
an organic insulating layer formed in a grating pattern overlapping the scanning line, the signal line, and the switching element;
a transparent electrode covering the organic insulating layer; and
an inorganic insulating layer located between the transparent electrode and the pixel electrode.
